(19) United States
(12) Patent Application Publication
(10) Pub. No.: US 2012/0191872 A1
(43) Pub. Date: Jul. 26, 2012

(54) SYSTEM AND METHOD FOR ASSURING SERVICE OF SESSIONS CREATED BY SESSION INITIATION PROTOCOL (SIP) IN AN INTERNET PROTOCOL NETWORK

(75) Inventors: Terry Prime, Herndon, VA (US); Wes Rogers, Herndon, VA (US)

(73) Assignee: nex Vortex, Inc., Herndon, VA (US)

(21) Appl. No.: 13/011,793

(22) Filed: Jan. 21, 2011

(51) Int. Cl. G06F 15/173; G06F 15/16

(52) U.S. Cl. 709/239

(57) ABSTRACT

A system for assuring service of SIP sessions in an internet protocol (IP) network, includes a plurality of probes connected to a plurality of network operators at a plurality of locations in the network and generating a plurality of event streams, and a service assurance manager which performs pattern matching to determine if an event pattern in the plurality of event streams matches a pre-defined event pattern, updates network data including a network operator data model and network routing characteristics based on a result of the pattern matching, and performs a correction based on the updated network data, the correction including avoiding a problematic portion of the network by one of session steering, session routing and session throttling.

### BACKGROUND OF THE INVENTION

1. Field of the Invention

The present invention relates to a system and method for assuring service of sessions created with the Session Initiation Protocol (SIP) in an internet protocol (IP) network, and more particularly, a system and method in which pattern matching is performed to determine if an event pattern in a plurality of event streams matches a pre-defined event pattern, and network operator data model and network routing characteristics are updated based on a result of the pattern matching.

2. Description of the Related Art

Internet Protocol (IP) networks commonly measure certain parameters at points in the network in order to verify that the network is operating correctly, and to ensure that an adequate quality of service (QOS) is being provided to the customers of the network.

FIG. 1 illustrates a related art network 100 which includes measuring probes S1 and S2 which are placed at the input of the network 100. When data passes through the probes S1, S2, the probes S1, S2 measure some parameters and supply the measured parameters to a measuring device (M).

The measuring device (M) transmits information to the probes concerning the measured parameters. The measuring device (M) can thus configure the data flows on which the measurements must be performed, as well as the periodicity of the measurements.

### SUMMARY OF THE INVENTION

However, conventional IP networks (e.g., the Internet) may have poor quality and reliability characteristics of sessions created by Session Initiation Protocol (SIP).

In view of the foregoing and other problems, disadvantages, and drawbacks of the aforementioned conventional systems and methods, an exemplary aspect of the present invention is directed to a system and method which may assure that sessions created by Session Initiation Protocol (SIP) have high quality and reliability characteristics.

An exemplary aspect of the present invention is directed to a system for assuring service of SIP sessions (i.e., sessions created with Session Initiation Protocol (SIP)) in an IP network. The system includes a plurality of probes connected to a plurality of network operators at a plurality of locations in the network, and generating a plurality of event streams, a service assurance manager (SAM) which performs pattern matching to determine if an event pattern in the plurality of event streams matches a pre-defined event pattern, and updates (e.g., in real-time) network data including a network operator data model and network routing characteristics based on a result of the pattern matching, and a routing device which performs a correction based on the updated network data, the correction including avoiding a problematic portion of the network by one of session steering, session routing and session throttling. The network operator data model and network routing characteristics for the network may be stored and/or maintained by the SAM.

Another exemplary aspect of the present invention is directed to a method of assuring service of SIP sessions in an IP network. The method includes generating a plurality of event streams, performing pattern matching to determine if an event pattern in the plurality of event streams matches a pre-defined event pattern, updating network data including a network operator data model and network routing characteristics based on a result of the pattern matching, and performing a correction based on the updated network data, the correction including avoiding a problematic portion of the network by one of session steering, session routing and session throttling.

Another exemplary aspect of the present invention is directed to a session steering technique that steers sessions to avoid networks with quality issues by forcing a different path for a media session by forcing the media session to an intermediary termination on a Back-to-back user agent (B2BUA) located on another network that is different than the IP network, and then on to the final destination. The correction performed in the inventive method may include the inventive session steering technique.

Another exemplary aspect of the present invention is directed to a programmable storage medium tangibly embodying a program of machine-readable instructions executable by a digital processing apparatus to perform a method of assuring service of SIP sessions in an IP network, the method including generating a plurality of event streams, performing pattern matching to determine if an event pattern in the plurality of event streams matches a pre-defined event pattern, updating network data including a network operator data model and network routing characteristics based on a result of the pattern matching, and performing a correction based on the updated network data, the correction including avoiding a problematic portion of the network by one of session steering, session routing and session throttling.

With its unique and novel features, the present invention may provide a system and method which may assure that sessions created by Session Initiation Protocol (SIP) have high quality and reliability characteristics.

### BRIEF DESCRIPTION OF THE DRAWINGS

The foregoing and other objects, aspects and advantages will be better understood from the following detailed description of the embodiments of the invention with reference to the drawings, in which:

FIG. 1 illustrates an IP network 100 according in the related art;

FIG. 2A illustrates a system 200 for assuring service of SIP sessions in an IP network, according to an exemplary aspect of the present invention;

FIG. 2B illustrates a service assurance manager 230 according to an exemplary aspect of the present invention;

FIG. 3 illustrates a method 300 for assuring service of SIP sessions in an IP network, according to an exemplary aspect of the present invention;

FIG. 4 illustrates a system 400 including measuring probes A-D in the event cloud which monitors a different route to the same end point (e.g., End System 2), according to an exemplary aspect of the present invention;

FIG. 5 illustrates the system 400 including measuring probes A-D in the event cloud which sends in real-time quality-of-service (QOS) measurement reports to a Service Assurance Manager (SAM), according to an exemplary aspect of the present invention;

FIG. 6 illustrates a system 600 including an SIP proxy 640 which routes SIP sessions, according to an exemplary aspect of the present invention;

FIG. 7 illustrates the system 600 in which SIP session routing is steered (e.g., forced) to the steering point back-to-back user agent (B2BUA) which is attached to an alternative network operator, according to an exemplary aspect of the present invention;

FIG. 8 illustrates a system 800 including an SIP proxy 840 which routes SIP sessions, according to an exemplary aspect of the present invention;

FIG. 9 illustrates the system 800 in which an SIP session is re-routed in a multi-homed IP end system using a routing point, according to an exemplary aspect of the present invention;

FIG. 10 illustrates a system 1000 including an SIP proxy 1040 which routes SIP sessions, according to an exemplary aspect of the present invention;

FIG. 11 illustrates the system 1000 in which an SIP session is throttled to an IP end system using a throttling point, according to an exemplary aspect of the present invention;

FIG. 12 illustrates a typical hardware configuration 1200 that may be used to implement the system and method (e.g., system 200 and method 300), in accordance with an exemplary aspect of the present invention; and

FIG. 13 illustrates a magnetic data storage diskette 1300 and compact disc (CD) 1302 that may be used to store instructions for performing the inventive method of the present invention (e.g., method 300), in accordance with an exemplary aspect of the present invention.

### DETAILED DESCRIPTION OF THE EXEMPLARY EMBODIMENTS OF THE INVENTION

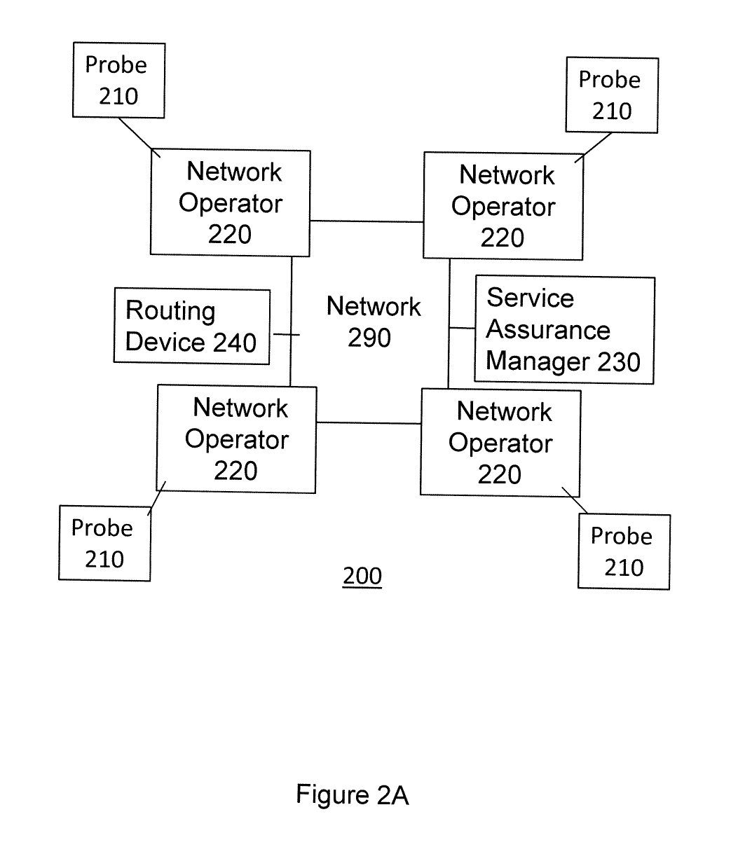

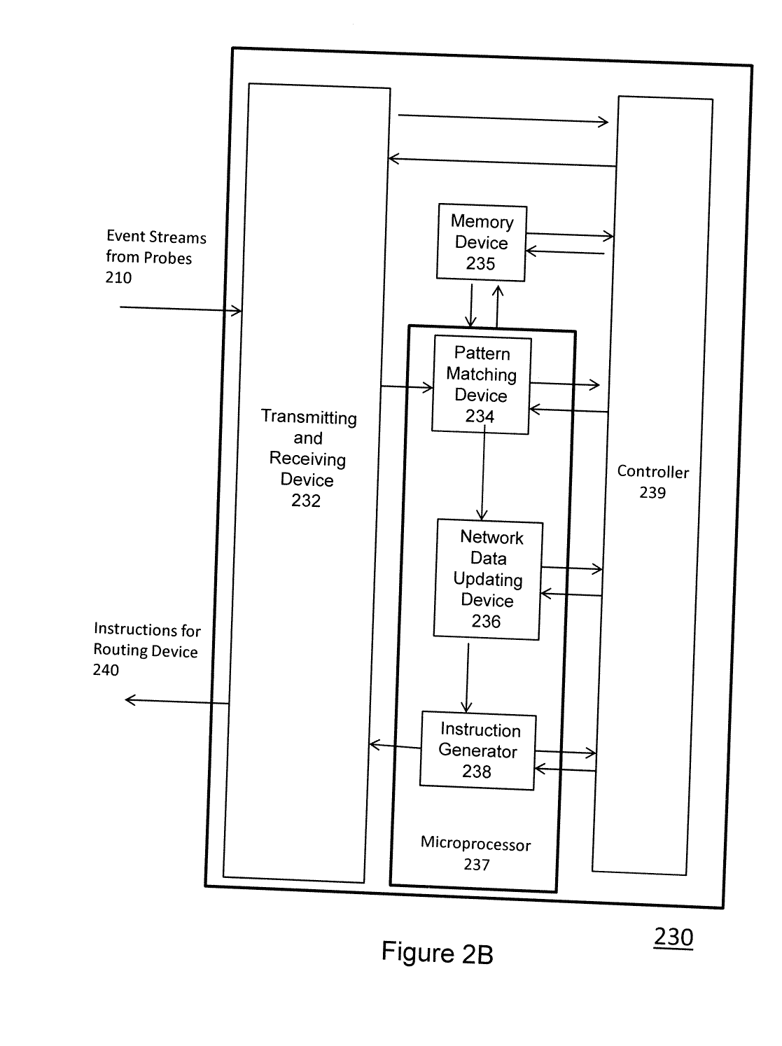

Referring now to the drawings, FIGS. 2-13 illustrate the exemplary aspects of the present invention.

As illustrated in FIG. 2A, an exemplary aspect of the present invention is directed to a system 200 for assuring service of SIP sessions in an IP network 290. The system 200 includes a plurality of probes 210 connected to a plurality of network operators 220 at a plurality of locations (e.g., respectively) in the network 290. The plurality of probes may generate a plurality of event streams (e.g., a probe of the plurality of probes may generate one or more event streams).

The system 200 also includes a service assurance manager (SAM) 230 which is connected to the network 290, performs pattern matching to determine if an event pattern in the plurality of event streams matches a pre-defined event pattern, and updates network data including a network operator data model and network routing characteristics based on a result of the pattern matching. The system 200 also includes a routing device 240 that performs a correction based on the updated network data, the correction including avoiding a problematic portion of the network by one of session steering, session routing and session throttling.

Thus, for example, if the event stream pattern matches the pre-defined pattern, then the SAM 230 may direct (e.g., control) the routing device 240 to perform (e.g., in real-time) the correction. Alternatively, if the event stream pattern does not match the pre-defined pattern, then the SAM 230 may direct (e.g., control) the routing device 240 to perform (e.g., in real-time) the correction.

The network data including, for example, network operator data model and network routing characteristics for the network may be stored and/or maintained by the SAM 230, or may be stored and/or maintained separately from the SAM 230. For example, network data such as the network operator data model and network routing characteristics for the network may be stored and/or maintained remotely from the SAM 430 in a device (e.g., memory device, server, etc.) which is connected (e.g., connected by wire or wirelessly connected) to the SAM 230. In this case, the SAM 230 may access and retrieve the network data when useful to the SAM 230 in performing the operations of the SAM 230 such as providing directions to the routing device 240.

FIG. 2B illustrates a service assurance manager 230 (SAM) according to an exemplary aspect of the present invention. As illustrated in FIG. 2B, the SAM 230 may include a transmitting and receiving device 232 (e.g., wired or wireless transceiver) for receiving the plurality of event streams from the probes 210, a pattern matching device 234 which may perform a pattern matching on the event streams received by the transmitting and receiving device 232 to determine if an event pattern in the plurality of event streams matches a pre-defined event pattern. The SAM 230 may also include a network data updating device 236 which updates network data including a network operator data model and network routing characteristics based on a result of the pattern matching.

The SAM 230 may also include an instruction generator 238 which generates an instruction for directing the routing device 240 to perform a correction (e.g., session steering, session routing and/or session throttling) based on the updated network data. As illustrated in FIG. 2B, the instruction generator 238 may output the instruction to the transmitting and receiving device 232 which may then transmit the instruction (e.g., by wired or wireless transmission) to the routing device 240.

The SAM 230 may include a microprocessor 237 (e.g., a plurality of microprocessors) which is connected to the transmitting and receiving device 232 and performs one or more of the functions of the pattern matching device 234, network data updating device 236 and instruction generator 238. The functions of the pattern matching device 234, network data updating device 236 and instruction generator 238 may also be software-implemented. That is, the SAM 230 may include a memory device 235 (e.g., programmable storage medium) which is accessible by the microprocessor 237 and which stores a software program of machine-readable instructions executable by the microprocessor 237 to perform the functions of the pattern matching device 234, network data updating device 236 and instruction generator 238.

The memory device 235 may store event data from event streams received by the transmitting and receiving device 232, and the microprocessor 237 may access the event data in the memory device 235 to perform complex event processing (e.g., event monitoring, event reporting, event recording and event filtering). In performing the complex event processing, the microprocessor 237 may rely on many techniques including, for example, event-pattern detection event abstraction, modeling event hierarchies detecting relationships (e.g., temporal relationships) between events, and abstracting event-driven processes.

An event may be observed in the system 200 as a change of state of the network 290 (e.g., a change in state of a route or end system in the network 290). The microprocessor 237 may record the event data in the memory device 235 as state information including an attached time stamp defining an order of occurrence and a topology mark defining the location (e.g., route, end system, etc.) of occurrence. For example, from the event data received by the SAM 230 in the plurality of event streams, the SAM 230 may infer (e.g., discover) a complex event (e.g., route failure, end system failure, etc.).

The SAM 230 may also include a controller 239 for controlling the operations of the SAM 230 (e.g., controls the transmitting and receiving device 232, and the microprocessor 237 including the pattern matching device 234, network data updating device 236 and instruction generator 238). In particular, feedback data on the performance of the system 200 (e.g., or performance of the network 290) may be generated by the microprocessor 237 (or input to the SAM 230 by a user of the system 200) and stored in the memory device 235. The controller 239 may periodically “fine-tune” the microprocessor 237 (e.g., improve a function of the pattern matching device 234, network data updating device 236 and instruction generator 238) based on the feedback data.

The event data from the plurality of event streams may also be used by the microprocessor 237 to generate history data which is stored in the memory device 235. For example, the history data may include, for example, a table which identifies an event pattern and a time that the event pattern was identified, an corrective action taken by the SAM 230 (e.g., microprocessor 237) in response to the event pattern and a time of the corrective action, and an effect that the response had on the performance of the network 290.

The microprocessor 237 may use the history data in the memory device to continually and automatically update the functions of the system 200 (e.g., train the system). The microprocessor 237 may also use the history data to predict that an issue (e.g., congestion in a particular route, etc.) may occur in the future. That is, the microprocessor 237 may apply predictive analytics (e.g., statistical analysis, data mining, Bayesian probabilities, neural networks, etc.) to the history data in order to predict that an issue may occur in the network 290 in the future, and may direct the routing device 240 to perform a pre-emptive correction (e.g., session steering, session routing and session throttling), based on the results of the predictive analytics.

The routing device 240 may include, for example, a server such as an SIP Proxy (e.g., SIP server or SIP proxy server). An SIP proxy may be used by SIP to perform many functions including call set-up functions in the IP network 290. In particular, the SIP proxy may be used to route requests to a user's current location, authenticate and authorize users for services, implement provider call-routing policies, and provide features to users. The SIP proxy may manage the setup of calls between SIP devices including the controlling of call routing and may also perform necessary functions such as registration, authorization network access control, and network security.

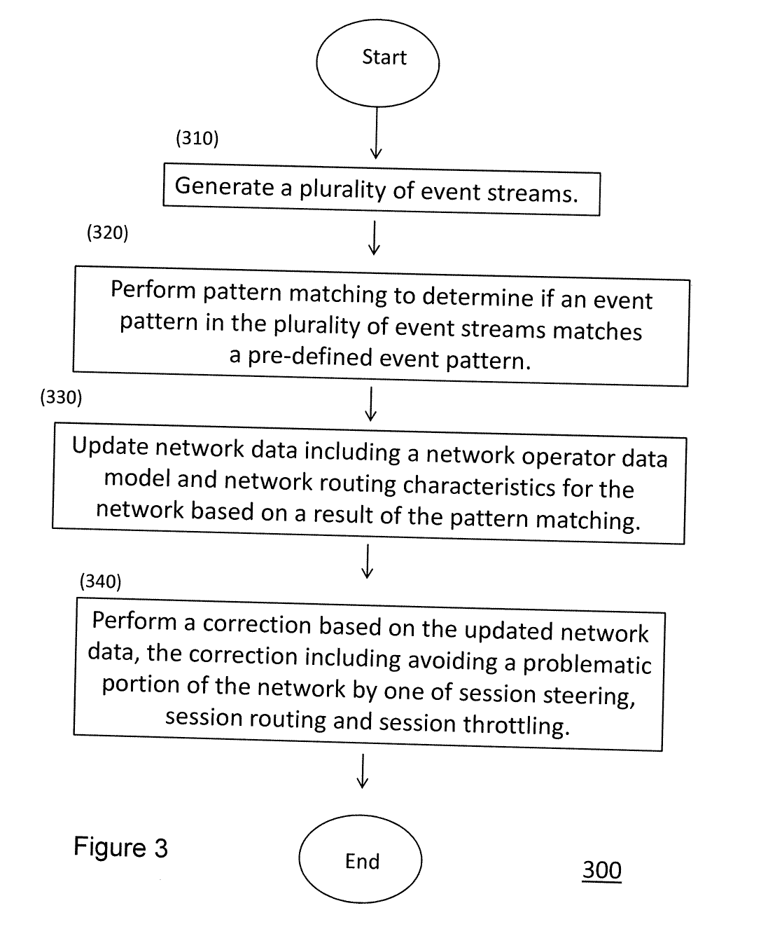

As illustrated in FIG. 3, another exemplary aspect of the present invention is directed to a method 300 of assuring service of SIP sessions in an IP network. The method 300 includes generating (310) a plurality of event streams, performing (320) pattern matching to determine if an event pattern in the plurality of event streams matches a pre-defined event pattern, updating (330) network data including a network operator data model and network routing characteristics for the network based on a result of the pattern matching, and performing (340) a correction based on the updated network data, the correction including avoiding a problematic portion of the network by one of session steering, session routing and session throttling. The network data including network operator data model and network routing characteristics for the network may be stored and/or maintained by a SAM connected to the network.

The exemplary aspects of the present invention provide real-time Quality Of Service (QOS) triggered steering, routing and throttling Points in Internet Protocol (IP) networks using Session Initiation Protocol (SIP) and Complex Event Processing (CEP). These features of the exemplary aspects of the present invention may help to improve the quality and reliability characteristics of sessions created by Session Initiation Protocol (SIP) over Internet Protocol (IP) networks, such as the Internet. The present invention may be of particular value to (but is not limited to) Voice over IP (VoIP) sessions.

The exemplary aspects of the present invention may be implemented using functionalities including Complex Event Processing (CEP) and Event Stream Processing (ESP). These functionalities may be embodied, for example, in the Service Assurance Manager (SAM) 230 with the probes 210 (e.g., widely distributed measuring probes) delivering event streams to the SAM 230. Thus, steering, routing and throttling may be implemented in the SAM 230 as complex event patterns.

In an exemplary aspect of the present invention, the system 200 may be connected to (e.g., operate on) an IP network 290 which includes a plurality of networks connected together (e.g., an Internet backbone connected to a plurality of network operators 220) to provide an end-to-end path. In the system 200, the probes 210 (e.g., measuring probes) may be placed at multiple IP address locations on the different network operators 220. Measurements may be taken by the probes 220 between a source location (e.g., an initial network operator 220) and each hop (e.g., network operator 220) on the route to a destination location (e.g., a final network operator 220), each at a specific IP address forming a mesh (e.g., network) of measuring probes 220 with overlapping routes.

If a probe 210 taken at a hop within a transit network (e.g., network operator 220) generates an “out of limit” measurement or a measurement event pattern that is defined as “out of limit”, the network operator 220 and route may be identified in an event or series of events and sent to the SAM 230. The SAM 230 may analyze the event streams including locally generated temporal events for event pattern matching which may result specific network decisions. The overlapping routes may enable the SAM 230 to triangulate where issues such as congestion, failure, packet loss, packet delay, and route outage are experienced.

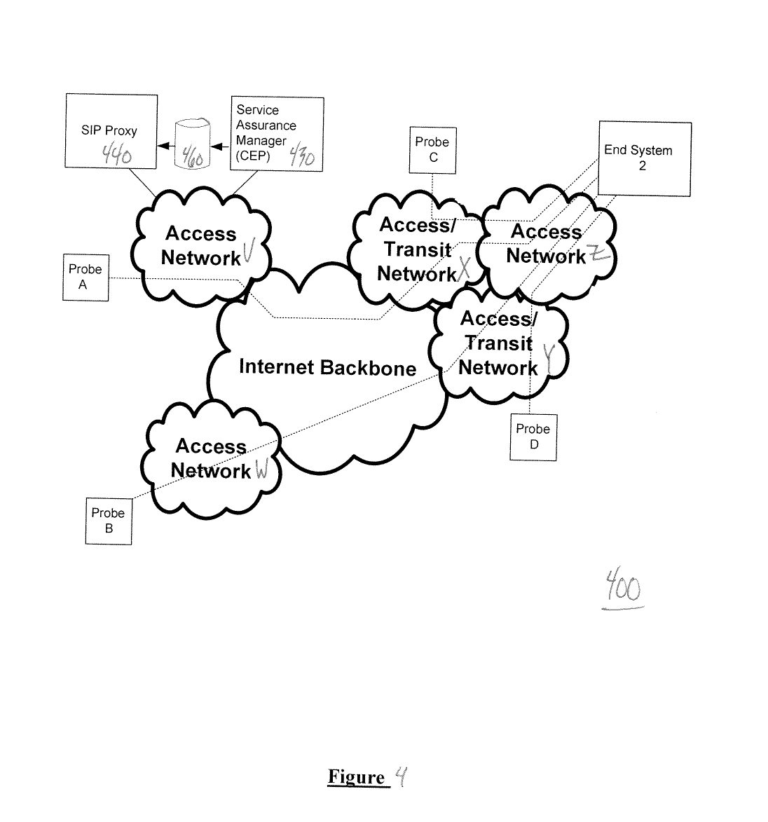

FIG. 4 illustrates another exemplary aspect of the present invention. This exemplary aspect may be especially applicable to (e.g., but not limited to) Voice over IP (VoIP) sessions by providing a level of Service Assurance Management.

As illustrated in FIG. 4, the system 400 for assuring service of SIP sessions in an IP network which includes an Internet Backbone, and a plurality of Access Networks and a plurality of Access/Transit Networks which are connected to the Internet Backbone.

The system 400 may include measurement probes connected to plurality of Access Networks and Access/Transit Networks (e.g., probes A-D connected to networks V-Y, respectively) including Access/Transit Networks X and Y, and Access Network Z at a plurality of locations in the IP network. The probes (e.g., each of the probes A-D) may generate a plurality of event streams.

The system 400 also includes a service assurance manager 430 (e.g., Complex Event Processor (CEP)) which may maintain a network operator data model, performs pattern matching to determine if an event pattern in the plurality of event streams matches a pre-defined event pattern, and updates the network operator data model and network routing characteristics based on a result of the pattern matching. The system 400 may also include a routing device 440 (e.g., SIP Proxy) and a memory device 460 (e.g., read only memory (ROM), random access memory (RAM), magnetic memory, etc.) which may store information such as network data including, for example, the network operator data model and network routing characteristics. The dotted line in FIG. 4 indicates a probe test in which measurement data generated by the probes A-D are transmitted from the probes A-D to the End System 2.

Data packets carrying session content can take any route through an IP network (e.g., the Internet) to reach a destination IP address. In practice, the data packets tend to take very similar routes particularly at a network operator level which has specific interconnect arrangements. This can change if something significant changes within the network. Session content can have a specific requirement, for example VoIP content is time sensitive and packet loss sensitive and can be adversely affected by jitter and echo. Multiple dynamics can influence these requirements including but not limited to congestion and failure.

The exemplary aspects of the present invention may improve the quality and reliability of sessions in the network (e.g., may correct congestion and failure) by monitoring the dynamics of network elements within the IP network that impact a particular type of session content and in real-time modify the SIP proxy routing of future sessions. An objective of an exemplary aspect of the present invention is to measure the dynamics of routes in the IP network to an IP endpoint address from different IP addresses located on different network operators and feed these QOS event streams back to the Service Assurance Manager 430 (e.g., Service Assurance Management function), which may include a Complex Event Processor (CEP).

In this exemplary aspect of the present invention, the probes A-D (e.g., measuring probes) may be placed at multiple points in the IP network (e.g., event cloud), each of the probes being on a separate network operator (e.g., access network or access/transit network). The probes A-D (e.g., each of the probes) are provided with a list of endpoint IP addresses to monitor. Multiple techniques (e.g., a combination of trace route and ping) may be used (e.g., by the probes) to monitor the route to an IP endpoint (e.g., End System 2) based on the dynamics that affect the session content being transmitted, to identify the hops to an endpoint and to measure the response time and packet loss to each hop.

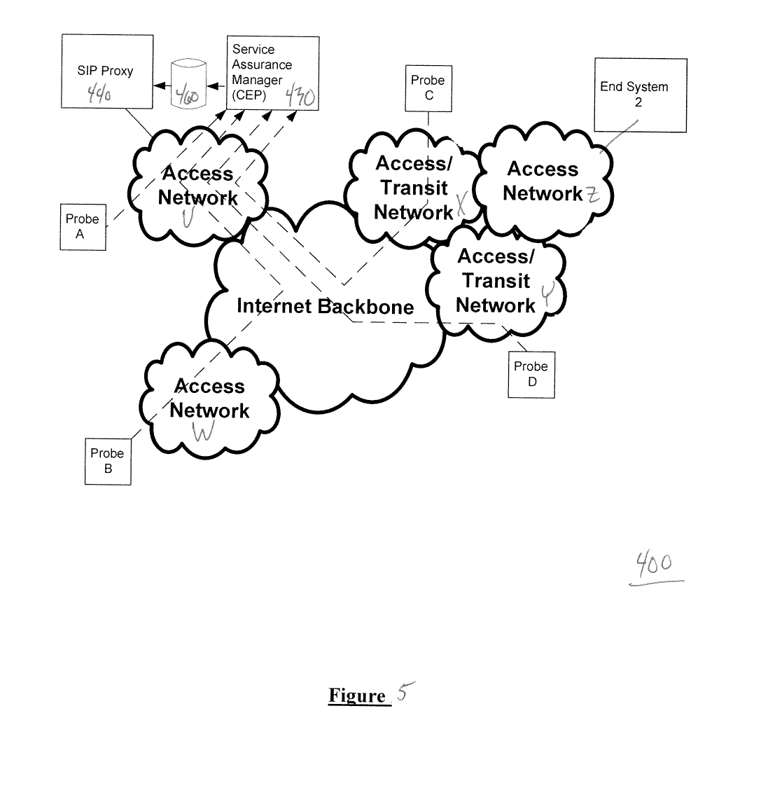

Network Operator information can also be ascertained from the monitoring or preprogrammed knowledge of the IP addresses. Each probe may monitor a different route to the same end point as can be seen in FIG. 4. Each probe sends in real-time, QOS events to a Service Assurance Manager (SAM) as can be seen in FIG. 5, and the SAM may analyze the event patterns in the measurement event stream using a CEP and update the network operator data model (e.g., and the network routing characteristics). A mesh of measurement routes may, thus, be created enabling triangulation of the results.

The dashed line in FIG. 5 indicates a Quality of Service (QOS) Report which is generated by the probes A-D and transmitted from the probes A-D to the Service Assurance Manager 430.

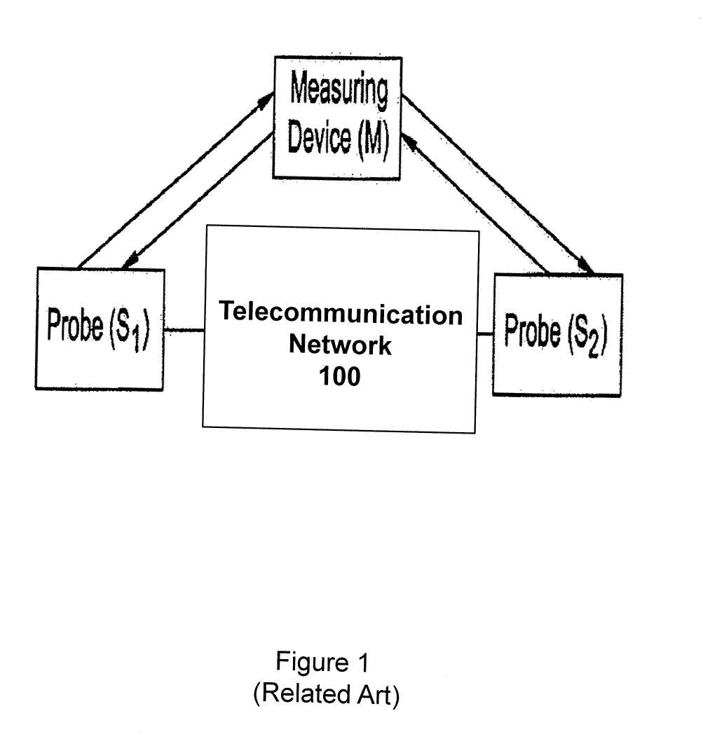

If QOS measurements to an IP end point are detected as “out of limit”, the measuring probes (e.g., monitoring probes) experiencing the issue, i.e. those probes with a common route over the network operator with the issue, may report the “out of limit” status events for this route to the Service Assurance Manager function. In the exemplary aspect of the present invention in FIG. 1, if network operator X is experiencing a single or multiple network nodes issues, then probes A and C will report “out of limit” measurements to End System 2 and probes B and D will report “within limit” measurements to End System 2 to the Service Assurance Manager 430.

This exemplary aspect of the present invention includes implementation of many measuring probes (e.g., probes A-D) forming an event cloud, and utilizing many measurements to many IP endpoints (e.g., end system 2) creating a detailed mesh of measurements over the IP networks (e.g., access networks and access/transit networks). Thus, a network operator experiencing an issue will be reported to the SAM 430 by one or more measurement probe event streams, allowing the network operator data model (e.g., and the network routing characteristics) to be updated in real-time by the SAM 430.

The features measured by the probes may be based on the connection point. That is, a probe in the plurality of probes may be tailored to measure features that are appropriate for the connection point at which the probe is located. The features to be measured by the probes may include, for example, packet loss above a preset limit, jitter above a preset limit, round trip delay above a preset limit to each router hop back to the SAM. A probe at a Public Switch Telephone Network (PSTN) connectivity point, for example, may also include availability of the connection and Continuity Tests (COT) along analog and digital links.

Further, the probes may connect to the IP network through an IP network card and connection. In particular, SAM, B2BUA, and SIP proxies may connect to the IP network through an IP network card and connection.

An important feature of an exemplary aspect of the present invention, is that the actions of the system may be triggered automatically (e.g., in real time), so that a user is not required to maintain or monitor the system. Any issue with a probe not responding to the SAM (e.g., the SAM heartbeat) will trigger an alert to network operations that the probe has lost connectivity or is out of service. Network Operations may use standard monitoring tools to track the availability or errors in the SAM servers and application.

Further, the exemplary aspects of the present invention may utilize one or more techniques (e.g., individually or in combination) to provide network level steering of session content packets (e.g., Real-Time Protocol (RTP) packets), network level routing of session content packets, and capacity throttling of session content packets, by utilizing SIP and Quality Of Service (QOS) events generated by the probes A-D forming an event cloud. The particular mode of correction (e.g., steering points, routing points or throttling points) or modes of correction to be used by the system 400 may be determined based on the circumstances. These modes of correction (e.g., steering points, routing points and throttling points) which may be used (e.g., individually or in combination) in the exemplary aspects of the present invention are described in more detail below.

Steering Points (e.g. Real-Time Quality of Service (QOS) Triggered Steering Points)

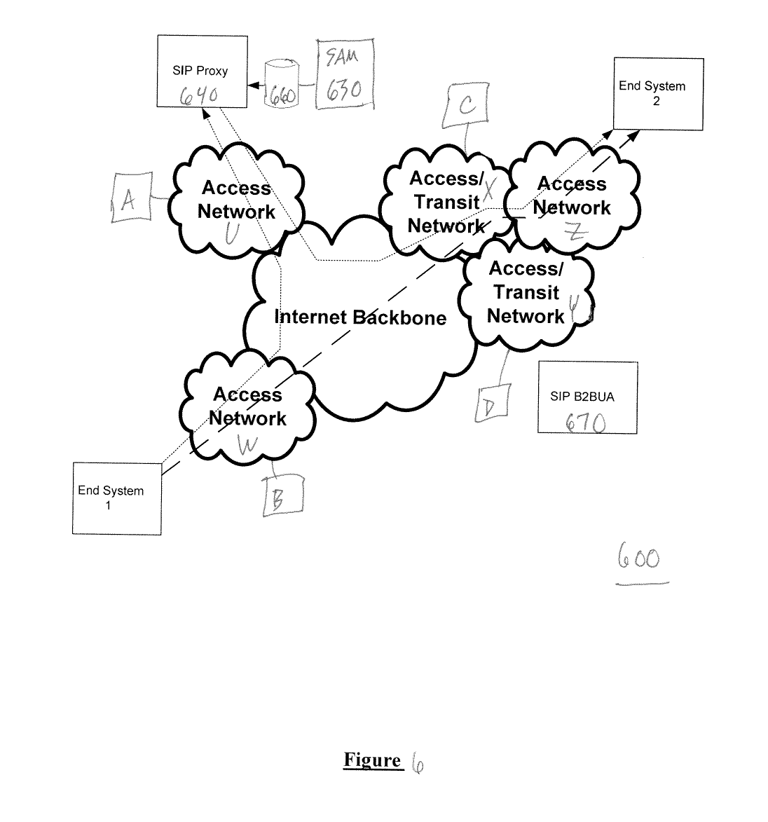

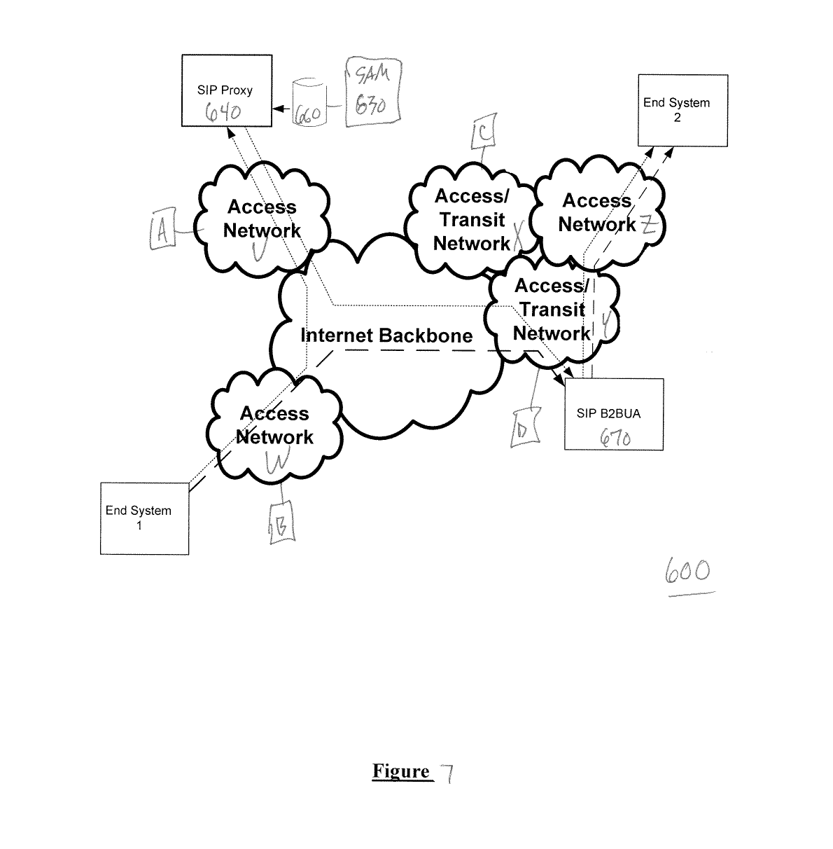

FIGS. 6 and 7 illustrate a system 600 for assuring service of SIP sessions in an IP network, according to an exemplary aspect of the present invention. The system 600 may include the features of system 400 described above with respect to FIGS. 4 and 5.

Similarly to the system 400, the system 600 may be implemented in (e.g., operate on) an IP network including an Internet Backbone and a plurality of Access Networks and a plurality of Access/Transit Networks which are connected to the Internet Backbone. The system 600 may include a plurality of measurement probes connected to the plurality of Access Networks and Access/Transit Networks (e.g., probes A-D connected to networks V-Y, respectively) including Access/Transit Networks X and Y, and Access Network Z at a plurality of locations in the network, and may also include a service assurance manager 630 (e.g., Complex Event Processor (CEP)), a routing device 640 (e.g., SIP Proxy) and a memory device 660 (e.g., read only memory (ROM), random access memory (RAM), magnetic memory, etc.) which may store and/or maintain information including, for example, the network operator data model and network routing characteristics for the network. The dotted line in FIGS. 6 and 7 indicates an SIP signaling path and the dashed line in FIGS. 6 and 7 indicates an Real-time Transport Protocol (RTP) path.

The system 600 may also include one or more steering point 670 (e.g., a Back-To-Back User Agent (B2BUA)), and if a network operator (e.g., Access/Transit Network) exhibits an issue, then the steering point 670 may terminate SIP signaling and session content (RTP) data streams and steer (e.g., forces) the SIP content via a specific network operator route to avoid the network operator exhibiting the issue. That is, route selection may identify a single, or multiple transit B2BUAs to force the content to avoid a specific transit network with an issue. This is network operator level route selection. That is, the system 600 may force the network operator path of SIP sessions by using steering points based on SIP B2BUAs.

If VoIP is considered as the SIP application example, then it can be seen in FIG. 6 that the SIP signaling messages (e.g., the dotted line in FIG. 6) may traverse from End System 1 to the SIP proxy which resolves the route to End System 2. The signaling messages then traverse via network operator X and Z to end system 2 (e.g., the IP endpoint). The session content (RTP) (e.g., the dashed line in FIG. 6) is largely routed in this example also via network operators X and Z.

The Service Assurance Manager 630 may analyze the input event streams against pre-defined event patterns. By triangulating the “within limit” and “out of limit” event streams from the various probes to the IP end points (e.g., End System 1 and End System 2), the Service Assurance Manager 630 determines that access network Y and Z are unlikely to be failing as probes B and D are reporting “within limit” measurements and that it is network operator X that is failing as that is the remaining common route for probes A and C. The Service Assurance Manager 630 updates (e.g., in real time) its network operator data model (e.g., and network routing characteristics) to indicate that network operator X has an issue.

In this example, the SIP Proxy 640 which had been routing sessions directly to End System 2, may query the network operator data model on the next session request, determine the route via network X to be problematic (e.g., the route is experiencing an issue), and trigger steering point logic to steer signaling and content via network operator Y. The SIP Proxy 640 may achieve this by routing to the steering point 670 (e.g., B2BUA) attached to network operator Y forcing the SIP session to network operator Y before being forwarded to End System 2 via network Z, as can be seen in FIG. 7.

This exemplary aspect of the present invention may utilize multiple B2BUAs to provide more granular and complex session steering. Additionally, sessions in progress can also have existing session content routing modified to route via a B2BUA steering point utilizing third party call control triggered by the Service Assurance Manager 630. In this scenario after it is determined that a network operator route including a network operator (e.g., Access/Transit Network X) is a faulty network operator route, a check is made to determine if there are existing sessions using that faulty route, and if it is determined that there are existing sessions using that faulty route, then a third party call control may transfer those existing sessions to include the B2BUA so that session signaling and content changes from the faulty route to another network operator route.

Thus, in summary, the system 600 may utilize measuring probes that take measurements to specified IP addresses and provide real-time QOS event feeds to the Service Assurance Manager 630 (e.g., Service Assurance Management function) which may include a Complex Event Processor (CEP), which in turn matches the QOS patterns and constructs a data model of problematic network operators and routes. If a session request is deemed to route through a problematic portion of the network (e.g., a portion experiencing an issue), then the SAM 630 will trigger session content steering point logic using a steering point 670 (e.g., B2BUA).

The quality of the content delivered can be improved with respect to the dynamics that affect it, if the route to specific end points (e.g., End System 1 and End System 2) can be monitored and measured against pre-specified limits. If it is judged that the measurements exceed the limits, then event patterns may be identified by the SAM 630, which may then take action to trigger the steering of the content away from the troublesome network for the current and future sessions.

The Service Assurance Manager 630 may be implemented using complex events pattern matching to identify QOS or reliability issues reported in real-time event streams from the measuring probes (event cloud) each taking measurements at specific IP addresses. The event patterns for this “Steering Point” mode of correction may be matched in the SAM 630 and trigger steering point logic. The steering point logic may ensure that subsequent SIP sessions are routed via one or more steering points (e.g., a single or multiple transit Back-To-Back User Agents (B2BUA)) that terminate the SIP signaling and session content (RTP) data streams and steer (e.g., force) the SIP content via a specific network operator route to avoid the network operator exhibiting the issue.

The B2BUAs may be configured to terminate both SIP signaling and session content and may be located on separate and various IP network operators known to have different interconnect relationships. The CEP pattern logic the system 600 may identify the network router path and the faulty network operator having measurements which are “out of limit”, and select the steering points (e.g., transit B2BUAs) that enable session content to avoid the faulty network operator. The SAM 630 may also update a network operator or network route map so that future SIP sessions avoid the problematic routes (e.g., routes experiencing an issue).

### Routing Points (e.g., Real-Time Quality Of Service (QOS) Triggered Routing Points)

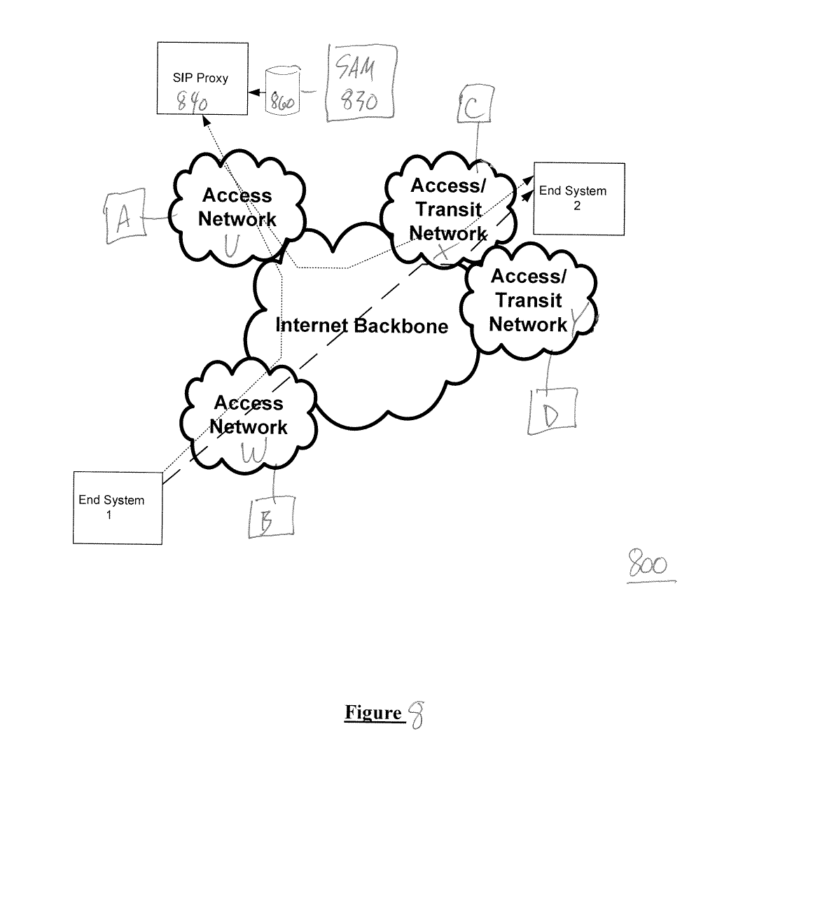

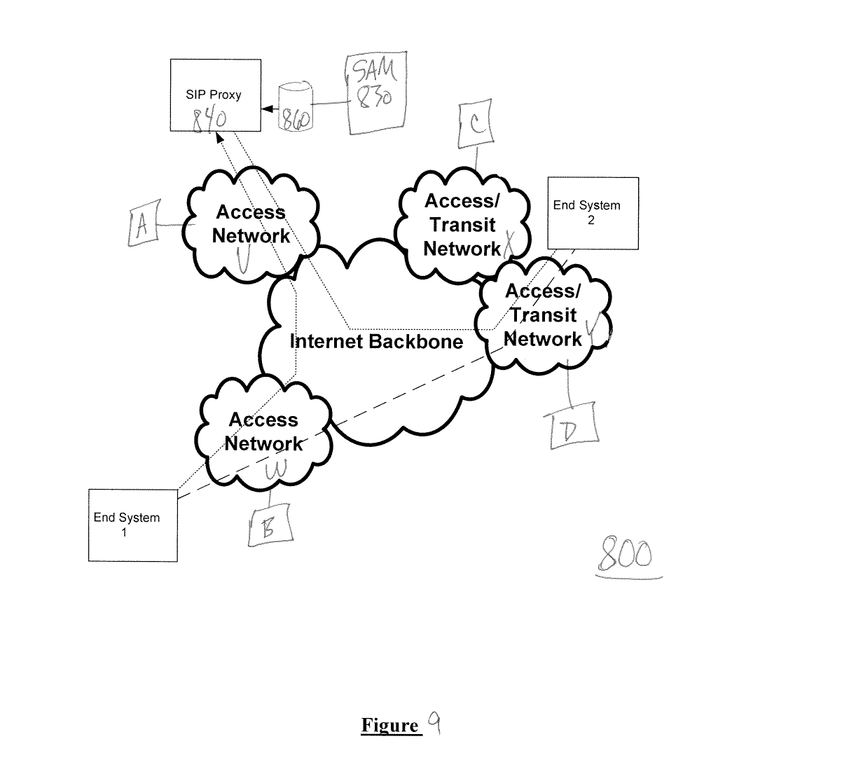

FIGS. 8 and 9 illustrate a system 800 for assuring service of SIP sessions in an IP network, according to an exemplary aspect of the present invention. The system 800 may include the features of system 400 described above with respect to FIGS. 4 and 5.

Similarly to the system 400, the system 800 may be implemented in an IP network including an Internet Backbone and a plurality of Access Networks and a plurality of Access/Transit Networks which are connected to the Internet Backbone. The system 800 may include a plurality of measurement probes connected to the plurality of Access Networks and Access/Transit Networks (e.g., probes A-D connected to networks V-Y, respectively) including Access/Transit Networks X and Y at a plurality of locations in the network, and may also include a service assurance manager 830 (e.g., Complex Event Processor (CEP)), a routing device 840 (e.g., SIP Proxy) and a memory device 860 (e.g., read only memory (ROM), random access memory (RAM), magnetic memory, etc.) which may store information including, for example, the network operator data model and network routing characteristics for the IP network. The dotted line in FIGS. 8 and 9 indicates an SIP signaling path and the dashed line in FIGS. 8 and 9 indicates an RTP path.

Route selection identifies a single or multiple alternative routes to avoid on a specific network with the issue. This is network level route selection.

In this exemplary aspect of the present invention, the SIP session may be re-routed on an alternative network operator based on a data model of the underlying network's good and bad routes.

In particular, in this exemplary aspect of the present invention, the end system may be “multi-homed” (i.e., the end system may be connected to two separate networks, each from a different network operator).

Further, each probe sends in real-time QOS events to a Service Assurance Manager (as can be seen in FIG. 5) which analyzes the event patterns in the measurement event stream using a CEP and updates the network operator data model (e.g., and network routing characteristics). A mesh of measurement routes is created which may enable the SAM to triangulate the results (e.g., triangulate the “within limit” and “out of limit” event streams from the plurality of probes to IP end points).

If VoIP is used as the SIP application example, then it can be seen in FIG. 8 that the SIP signaling messages traverse from End System 1 to the SIP proxy 840 which resolves the route to End System 2. The signaling messages (i.e., the dotted line in FIG. 8) then traverse via network operator X to the IP endpoint (i.e., End System 2). The session content (RTP) (e.g., the dashed line in FIG. 8) is routed in this example also via network operator X.

The number of probes and the placement of the probes may vary depending upon the circumstances. For example, the number and placement of the probes may be such that some redundancy is provided in the data (e.g., event streams) transmitted from the probes to the SAM 830. That is, the number and placement of the probes may be sufficient to provide predictability in the event that a probe (e.g., a probe attached to network X) does not detect an “issue” in the network.

The Service Assurance Manager 830 analyses the real-time input event streams against pre-defined event patterns. By triangulating the “within limit” and “out of limit” event streams from the various probes to the IP end points (e.g., End System 1 and End System 2) the Service Assurance Manager 830 determines that access network Y is unlikely to be failing as probes B and D are reporting “within limit” measurements, and that it is network operator X that is failing as that is the remaining common route for probes A and C. The Service Assurance Manager 830 updates its network operator data model (e.g., and network routing characteristics) to indicate that network operator X has an issue.

This exemplary aspect of the present invention may include implementation of many monitor probes (e.g., measurement probes), utilizing many measurements to many IP endpoints creating a detailed mesh of measurements over the IP networks. That is, the invention may utilize many probes to provide more granular and complex monitoring mesh.

Further, in this exemplary aspect of the present invention, the SIP Proxy 840 which had been routing sessions directly to End System 2 may query the network operator data model on the next session request, determine the route via network X to be problematic (e.g., the route via network X is experiencing an issue), and trigger re-routing of the signaling and content via network operator Y. It achieves this by routing to a multi-homed alternative IP address using network Y, as can be seen in FIG. 9.

Thus, in summary, the system 800 may utilize measuring probes that take measurements to specified IP addresses and provide real-time QOS event feeds to the SAM 830 (e.g., Service Assurance Management function) which may include a Complex Event Processor (CEP), which in turn matches the QOS patterns and constructs a data model of problematic network routes and operators. If a session request is deemed to route through a problematic access route to the end system and that end system includes multi-homed IP addresses, then the SAM 830 may trigger session content routing point logic.

Multi-homed IP end systems may be defined, for example, as end systems with multiple IP trunks with unique IP addresses, often on different network operators to provide redundancy and load balancing. The quality of the content delivered can be improved with respect to the dynamics that affect it, if the access route to a specific end point can be monitored and measured against pre-specified limits. If it is judged by the SAM 830 that the measurements exceed the limits, then the SAM 830 may take action to trigger routing of the content away from the troublesome access network to an alternative access network for the current and/or future sessions.

The Service Assurance Manager 830 may be implemented using complex events pattern matching to identify QOS or reliability issues reported in real-time event streams from measuring probes (event cloud) from the end point systems and other points in the IP network. The event patterns for this mode of correction may be matched in the SAM 830 that can be corrected or impact reduced by triggering routing point logic. Routing point logic ensures subsequent SIP sessions are routed to a different IP address “Routing Point” in a multi-homed end system. This CEP pattern can be used when there are issues being experienced in the access network of the end system.

For example, if the pattern is matched, then the network operator is identified, routing tables are updated and subsequent SIP sessions are routed to a different IP end point. IP packets can each take separate routes, so the system 800 may be especially effective for an issue in the access network that the IP end point is connected to or in the ingress or egress gateway of that access network, in which case the issue can be avoided by this alternate routing. The system 800 can still be effective in certain cases if the issue is not in the access network.

### Throttling Points (e.g., Real-Time Quality Of Service (QOS) Triggered Throttling Points)

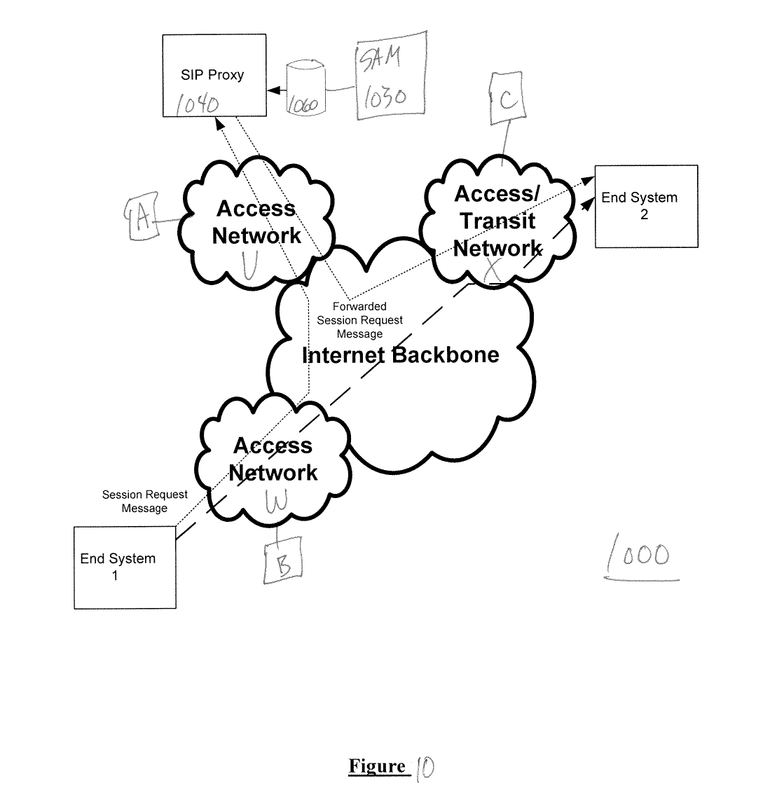

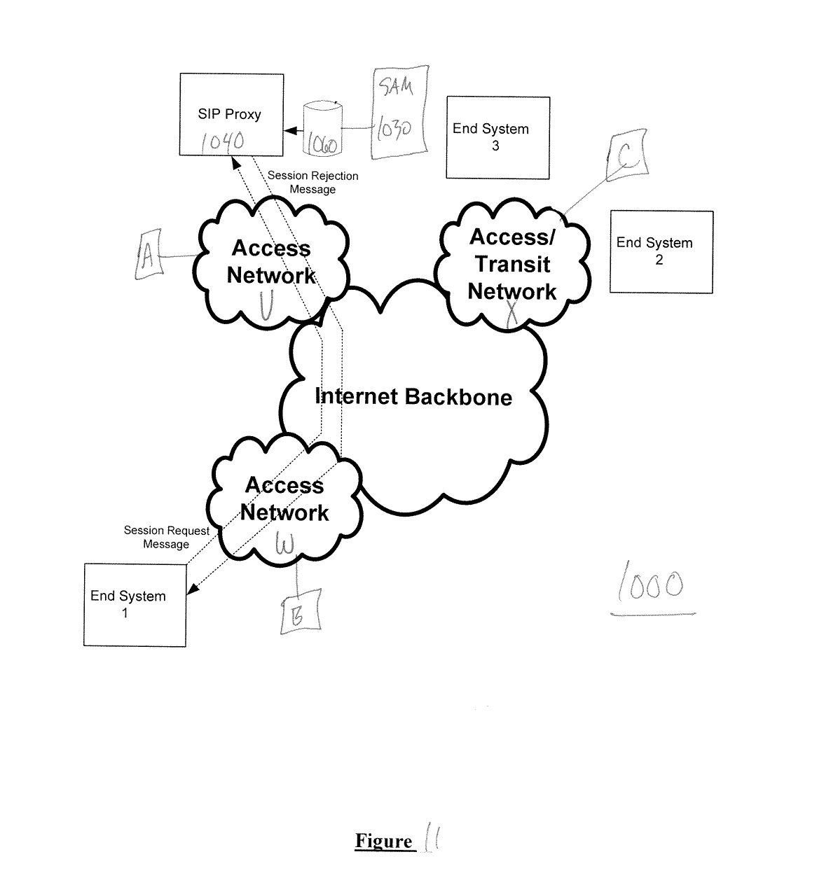

FIGS. 10 and 11 illustrate a system 1000 for assuring service of SIP sessions in an IP network, according to an exemplary aspect of the present invention. The system 1000 may include the features of system 400 described above with respect to FIGS. 4 and 5.

Similarly to the system 400, the system 1000 may be implemented in (e.g., operate on) an IP network including an Internet Backbone and a plurality of Access Networks and a plurality of Access/Transit Networks which are connected to the Internet Backbone. The system 1000 may include measurement probes connected to the plurality of Access Networks and Access/Transit Networks (e.g., probes A-C connected to networks V-X, respectively) including Access/Transit Network X at a plurality of locations in the network, and may also include a service assurance manager 1030 (e.g., Complex Event Processor (CEP)), a routing device 1040 (e.g., SIP Proxy) and a memory device 1060 (e.g., read only memory (ROM), random access memory (RAM), magnetic memory, etc.) which may store information including, for example, the network operator data model and network routing characteristics. The dotted line in FIGS. 10 and 11 indicates an SIP signaling path (e.g., session request message and forwarded session request message) and the dashed line in FIGS. 10 and 11 indicates an RTP path.

This exemplary aspect may monitor the dynamics of network elements within IP networks that impact a particular type of session content, and in real-time modify the SIP proxy routing to reject future sessions to a congested route or re-route future sessions to avoid the congested route. This may provide an existing connection with more of the available bandwidth and effectively throttle the connections dynamically based on the measurements that are transmitted from the probes to the SAM 1030 for that route.

That is, this exemplary aspect of the present invention may throttle (e.g., dynamically reduce and increase) the number of sessions through a particular route (e.g., specific route under measurement).

In particular, if VoIP is considered as the SIP application example, it can be seen in FIG. 10 that the SIP signaling messages (e.g., the dotted line in FIGS. 10 and 11) traverse from End System 1 to the SIP proxy 1040 which resolves the route to End System 2. The signaling messages then traverse via network operator X to the IP endpoint (e.g., End System 2). The session content (RTP) (e.g., the dashed line in FIGS. 10 and 11) is also routed in this exemplary aspect via network operator X.

If QOS measurements to an IP end point are detected as “out of limit”, the measuring probes experiencing the issue, those with a common route over the network operator with the issue, report the “out of limit” status for this route to the Service Assurance Manager function. Thus, in system 1000, for example, if an access connection between End System 2 and network operator X is experiencing an issue, then probes A, B and C will report “out of limit” measurements on the final hop to End System 2 to the Service Assurance Manager 1030.

The Service Assurance Manager 1030 analyzes the real-time input event streams from the measurement probes A-C. Thus, for example, by triangulating the “within limit” and “out of limit” event streams from the various probes A-C to the IP end points (e.g., End System 1 and End System 2), the Service Assurance Manager 1030 may determine that the connection between End System 2 and access network X is likely to be failing as probes A, B and C are reporting “out of limit” measurements on the final hop to End System 2. The Service Assurance Manager 1030 may thus, update its network operator data model (e.g., and network routing characteristics) to indicate the connection from End System 2 to network operator X has an issue.

Further, in this exemplary aspect of the present invention, the SIP Proxy 1040 which had been routing sessions directly to End System 2 queries the network operator data model on the next session request, determines the access connection to network X for End System 2 is problematic (e.g., is experiencing an issue) and triggers throttling by rejecting further session requests to and from End System 2 as illustrated in FIG. 11.

It should be noted that access routers can prioritize time sensitive sessions from a system such as End System 2 outbound to the network but cannot prioritize time sensitive sessions to a system such as End System 2 from the network. Therefore, this exemplary aspect of the present invention may have particular relevance in this scenario. Priority can also be set in the SAM 1030 for certain inbound calls based on the Caller ID or source IP address (e.g., emergency call back).

Further, corrections to the connection between End System 2 and network X (e.g., reduction in bandwidth usage) may be reported by the measurement probes A-C allowing the network operator data model to be updated in real-time and future session requests to and from End System 2 to again be routed by the SIP proxy 1040.

Thus, in summary, the system 1000 may utilize measuring probes that take measurements to specified IP addresses and provide real-time QOS event feeds to the Service Assurance Manager 1030 (e.g., Service Assurance Management function) which may include a Complex Event Processor (CEP), which in turn matches the QOS patterns and constructs a data model of problematic network routes and operators experiencing bandwidth capacity issues. For those routes experiencing an issue (e.g., bandwidth capacity issues) the SAM 1030 may reduce the maximum number of sessions that can be established through that route.

After a configurable time interval (CEP temporal event), if no further “out of limit” event reports are received for the point under measurement, or if “within limit” events are received, then the maximum session count is again incremented providing a dynamic throttle of sessions that can be established through that route. If a future session request is deemed to route through a problematic route and the available sessions count is met or exceeded, then the session may be either re-routed through a hop with available bandwidth, or may be refused with a busy response if no available alternative route is available. In this way the existing session quality may be maintained.

The quality of the content delivered can be improved with respect to the dynamics that affect it, if the route to specific end points can be monitored and measured against pre-specified limits. If it is judged that the measurements from the plurality of probes exceed the congestion limits, then the SAM 1030 may take action to trigger the throttling or re-routing of session content to the network route experiencing or approaching congestion.

The Service Assurance Manager 1030 may be implemented using complex events pattern matching to identify QOS or reliability issues reported in real-time event streams from measuring probes (event cloud) each taking measurements at specific IP addresses. The event patterns for this mode of correction may be matched in the SAM 1030 that can be corrected or impact reduced by triggering throttling point logic. Throttling point logic ensures subsequent SIP sessions are declined to, or re-routed away from, a specific IP address “Throttling Point” to maintain the quality of the existing SIP sessions and alleviate (e.g., prevent) overloading and congestion.

This CEP pattern is particularly applicable to congestion issues being experienced in the inbound direction of an access network of the end system. Outbound SIP sessions are generally engineered to provide the required quality and not overload the access trunk. However, the IP network can switch as many SIP sessions as the network wants to the end point compromising the quality of all SIP sessions. This pattern may provide a mechanism to throttle and manage the inbound SIP sessions.

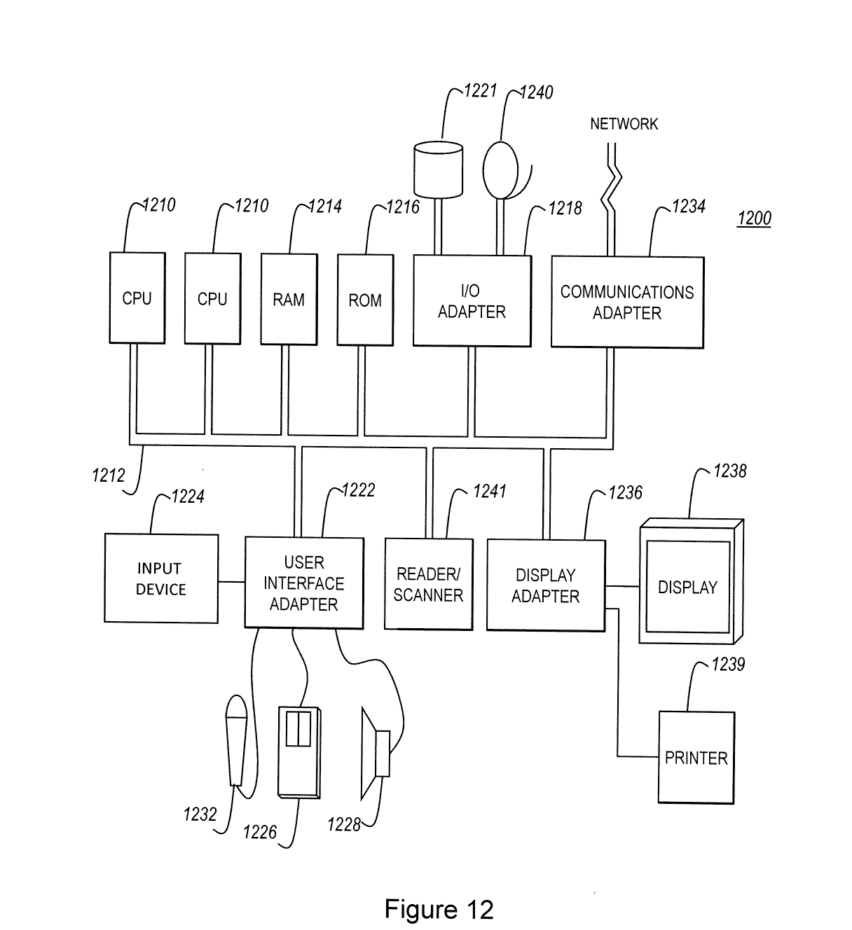

Referring now to FIG. 12, system 1200 illustrates a typical hardware configuration which may be used for implementing the system and method of the present invention (e.g., systems 200, 400, 600, 800, 1000, and method 300). The configuration has preferably at least one processor or central processing unit (CPU) 1211. The CPUs 1211 are interconnected via a system bus 1212 to a random access memory (RAM) 1214, read-only memory (ROM) 1216, input/output (I/O) adapter 1218 (for connecting peripheral devices such as disk units 1221 and tape drives 1240 to the bus 1212), user interface adapter 1222 (for connecting a keyboard 1224, mouse 1228, speaker 1228, microphone 1232, pointing stick 1227 and/or other user interface device to the bus 1212), a communication adapter 1234 for connecting an information handling system to a data processing network, the Internet, an Intranet, a personal area network (PAN), etc., and a display adapter 1236 for connecting the bus 1212 to a display device 1238 and/or printer 1239. Further, an automated reader/scanner 1241 may be included. Such readers/scanners are commercially available from many sources.

In addition to the system described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media (e.g., non-transitory signal-bearing media).

Thus, this aspect of the present invention is directed to a programmed product, including signal-bearing media tangibly embodying a program of machine-readable instructions executable by a digital data processor to perform the above method.

Such a method may be implemented, for example, by operating the CPU 1211 to execute a sequence of machine-readable instructions. These instructions may reside in various types of signal bearing media.

Thus, this aspect of the present invention is directed to a programmed product, including signal-bearing media tangibly embodying a program of machine-readable instructions executable by a digital data processor incorporating the CPU 1211 and hardware above, to perform the method of the invention.

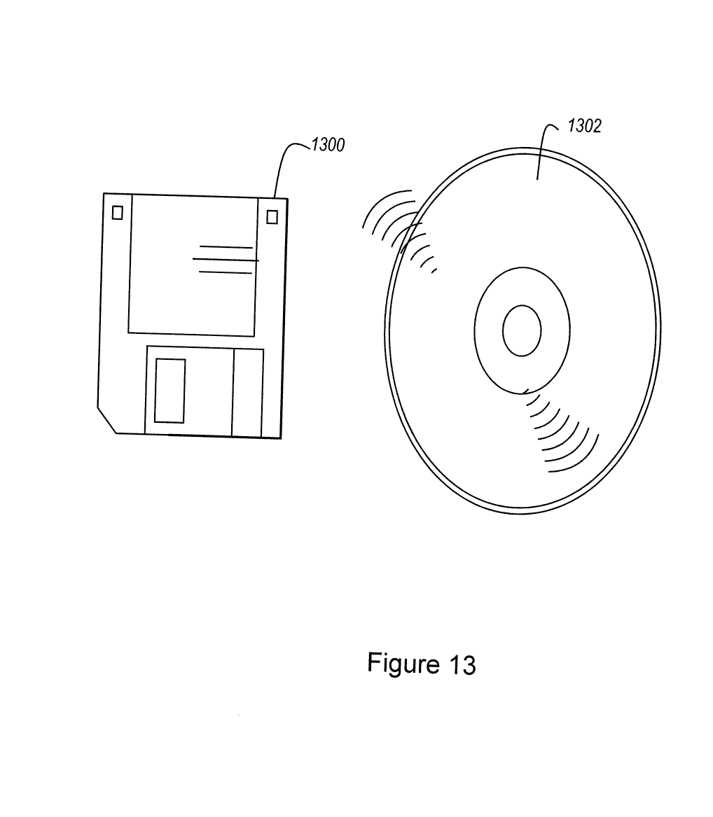

This signal-bearing media may include, for example, a RAM contained within the CPU 1211, as represented by the fast-access storage for example. Alternatively, the instructions may be contained in another signal-bearing media, such as a magnetic data storage diskette 1300 or compact disc 1302 (FIG. 13), directly or indirectly accessible by the CPU 1211.

Whether contained in the computer server/CPU 1211, or elsewhere, the instructions may be stored on a variety of machine-readable data storage media, such as DASD storage (e.g, a conventional “hard drive” or a RAID array), magnetic tape, electronic read-only memory (e.g., ROM, EPROM, or EEPROM), an optical storage device (e.g., CD-ROM, WORM, DVD, digital optical tape, etc.), paper “punch” cards, or other suitable signal-bearing media (e.g., non-transitory signal-bearing media). In an illustrative embodiment of the invention, the machine-readable instructions may include software object code, compiled from a language such as C, C++, etc.

With its unique and novel features, the present invention may provide a system and method which may assure that sessions created by Session Initiation Protocol (SIP) have high quality and reliability characteristics.

While the invention has been described in terms of one or more embodiments, those skilled in the art will recognize that the invention can be practiced with modification within the spirit and scope of the appended claims. Specifically, one of ordinary skill in the art will understand that the drawings herein are meant to be illustrative, and the design of the inventive assembly is not limited to that disclosed herein but may be modified within the spirit and scope of the present invention.

Further, Applicant's intent is to encompass the equivalents of all claim elements, and no amendment to any claim the present application should be construed as a disclaimer of any interest in or right to an equivalent of any element or feature of the amended claim.

What is claimed is:

1. A system for assuring service of session initiation protocol (SIP) sessions in an internet protocol (IP) network, comprising:
a plurality of probes connected to a plurality of network operators at a plurality of locations in the network, and generating a plurality of event streams;
a service assurance manager (SAM) which performs pattern matching to determine if an event pattern in the plurality of event streams matches a pre-defined event pattern, and updates network data including a network operator data model and network routing characteristics based on a result of the pattern matching; and
a routing device which performs a correction based on the updated network data, the correction including avoiding a problematic portion of the network by one of session steering, session routing and session throttling.

2. The system of claim 1, wherein the correction includes using a session steering technique that steers sessions to avoid networks with quality issues by forcing a different path for a media session by forcing the media session to an intermediary termination on a Back-to-back user agent (B2BUA) located on another network that is different than the IP network, and then on to a final destination.

3. The system of claim 1, wherein the service assurance manager comprises a complex event processor (CEP), and the pattern matching comprises complex event pattern matching, and
wherein the service assurance manager comprises session content steering point logic, session content routing point logic, and session content throttling point logic.

4. The system of claim 1, wherein the routing device under a direction of the service assurance manager, routes a session based on the updated network operator data model and the updated network routing characteristics.

5. The system of claim 4, wherein the routing device routes a session by performing network level steering of content packets of the session.

6. The system of claim 5, further comprising:
a Back-To-Back User Agent (B2BUA) which is located on the plurality of network operators, the plurality of network operators having different interconnect relationships in the network,
wherein the pattern matching indicates a network operator of the plurality of network operators exhibiting an issue, and the service assurance manager comprises steering point logic which directs the B2BUA to terminate SIP signaling and session content data streams and steer SIP content via a specific network operator route to avoid the network operator exhibiting the issue.

7. The system of claim 5, further comprising:
a plurality of B2BUAs which are located on the plurality of network operators,
wherein the service assurance manager comprises Complex Event Processing (CEP) pattern logic which:
identifies a network router path and a network operator of the plurality of network operators having a measurement from the plurality of probes which is out of limit;
selects a B2BUA from the plurality of B2BUAs that enables session content to avoid the identified network router path and the network operator; and
updates a network operator map or network route map such that a future SIP session avoids the identified network router path and network operator.

8. The system of claim 4, wherein the routing device routes a session by performing network level routing of content packets of the session.

9. The system of claim 8, wherein the service assurance manager comprises session content routing point logic which is triggered if a session request is deemed to route through an access route experiencing an issue to an end system comprising a multi-homed IP address end system.

10. The system of claim 9, wherein if the session content routing point logic is triggered, then the service assurance manager identifies an end system having an access route which is experiencing an issue, updates routing tables and directs the routing device to route subsequent SIP sessions to an end system which is different from the identified end system.

11. The system of claim 4, wherein the routing device routes a session by performing capacity throttling of session content packets of the session.

12. The system of claim 11, wherein the service assurance manager comprises throttling point logic, and if the throttling point logic is triggered, then the service assurance manager directs the routing device to decline a subsequent SIP session to an IP address throttling point, or re-route a subsequent SIP session away from an IP address throttling point to maintain a quality of an existing SIP session and alleviate overloading and congestion.

13. The system of claim 4, wherein the routing device comprises a Session Initiation Protocol (SIP) Proxy.

14. The system of claim 4, wherein the session comprises Real-Time Transport Protocol (RTP) packets and the plurality of event streams comprises Quality Of Service (QOS) events which are generated by the plurality of probes and form an event cloud.

15. The system of claim 1, wherein the pre-defined event pattern indicates an event in the network including one of packet loss, packet delay, and route outage.

16. The system of claim 1, wherein the plurality of probes comprises a probe at a source location in the network which is a source of the session, a probe at a destination location in the network which is a destination of the session, and a probe at a plurality of locations on a route from the source location to the destination location.

17. A method of assuring service of session initiation protocol (SIP) sessions in an internet protocol (IP) network, comprising:
generating a plurality of event streams;
performing pattern matching to determine if an event pattern in the plurality of event streams matches a pre-defined event pattern;
updating network data including a network operator data model and network routing characteristics based on a result of the pattern matching; and
performing a correction based on the updated network data, the correction including avoiding a problematic portion of the network by one of session steering, session routing and session throttling.

18. The method of claim 17, wherein the performing of the correction includes routing a session based on the updated network data.

19. The method of claim 17, wherein the generating of the plurality of event streams is performed by a plurality of probes connected to a plurality of network operators at a plurality of locations in the network,
wherein the network includes a service assurance manager and the performing of the pattern matching, the updating of the network data, and
wherein the network includes a routing device and the performing of the correction is performed by the routing device.

20. A programmable storage medium tangibly embodying a program of machine-readable instructions executable by a digital processing apparatus to perform a method of assuring service of session initiation protocol (SIP) sessions in an internet protocol (IP) network, the method comprising:
generating a plurality of event streams;
performing pattern matching to determine if an event pattern in the plurality of event streams matches a pre-defined event pattern;
updating network data including a network operator data model and network routing characteristics based on a result of the pattern matching; and
performing a correction based on the updated network data, the correction including avoiding a problematic portion of the network by one of session steering, session routing and session throttling.
